(19) United States
(12) Patent Application Publication
(10) Pub. No.: US 2008/0053627 A1
(43) Pub. Date: Mar. 6, 2008

(54) Winding apparatus for shades

(76) Inventor: Ya Li Lin, Shalu Township (TW)

Correspondence Address: BRUCE H. TROXELL, SUITE 1404, 5205 LEESBURG PIKE, FALLS CHURCH, VA, 22041, US

(21) Appl. No.: 11/512,411

(22) Filed: Aug. 30, 2006

(51) Int. Cl. E06B 9/30

(52) U.S. Cl. 160/170

(57) ABSTRACT

A winding apparatus for retractable shades that is simply structured and can be fabricated easily at a lower material cost includes an anchor dock, an elastic element, a rotary wheel and a cord winding dock. The anchor dock is installed on a transverse rod to be coupled by the elastic element and the rotary wheel, and has an anchor axle to hold the cord winding dock. The cord winding dock has at least one trough to be wound by a drawing cord of a retractable shade. By pulling an operation element of the rotary wheel the cord winding dock can be rotated to retract and extend the shade.

### BACKGROUND OF THE INVENTION

1. Field of the Invention

The present invention relates to a winding apparatus for shades and particularly to a winding apparatus for retractable shades that is simply structured and easy to fabricate to reduce costs.

2. Description of the Prior Art

A conventional shade winding apparatus such as the one disclosed in R.O.C. patent No. 94215870 includes a cord winding assembly on a upper side for each retracting cord. The cord winding assembly is located in a window covering track and requires a lot of time to install. Moreover, for a window shade of a larger size a plurality of retracting cords are needed. The number of the cord winding assembly has to match the retracting cords. Hence the cost is higher. Fabrication and maintenance also are more difficult. It is not economic effective. To remedy this problem, R.O.C. patent No. 94222057 proposes an improvement. However, it has a transmission wheel installed on an outer side of an anchor means that must be encased by a cover to prevent dusts or other objects from entering to cause transmission problem. Such an approach requires more elements and a greater longitudinal length on the shade winding apparatus. More installation constraints also occur. There are still rooms for improvement.

### SUMMARY OF THE INVENTION

In view of the aforesaid problems occurred to the conventional shade winding apparatus, the present invention aims to provide a winding apparatus for shades that is simply structured. It includes an anchor dock, an elastic element, a rotary wheel and a cord winding dock. The anchor dock is installed on a transverse rod and has an anchor axle in the center of an inner side. The anchor axle is surrounded by an annular holding trough. The anchor dock further has a coupling portion on an outer side. The elastic element is held in the holding trough, and has two legs on two ends. The rotary wheel is coupled on the anchor axle and driven by an operation element to rotate. It has a coupling aperture in the center and a thrust member extending rearwards to be coupled in the elastic element. The thrust member pushes the two legs of the elastic element to control rotation of the rotary wheel. The cord winding dock is coupled on a front side of the rotary wheel and has a winding shaft on one end that has at least one trough to be wound by a drawing cord of a shade and a coupling member on another end to wedge in the coupling aperture to be rotated synchronously with the rotary wheel. The cord winding dock also has an opening in the center to be run through by the anchor axle and fastened by a fastening element to anchor all the elements. The structure thus formed can be fabricated easier at a lower material cost.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a perspective view of the invention.

FIG. 2 is an exploded view of the invention.

FIG. 3 is a schematic view of an embodiment of the invention adopted for use on a window shade.

FIG. 4 is a sectional view of the invention.

FIG. 5 is another sectional view of the invention.

FIG. 6 is a schematic view of embodiment-1 of the invention.

FIG. 7 is a schematic view of embodiment-2 of the invention.

FIG. 8 is a schematic view of embodiment-3 of the invention.

FIG. 9 is a schematic view of embodiment-4 of the invention.

### DESCRIPTION OF THE PREFERRED EMBODIMENTS

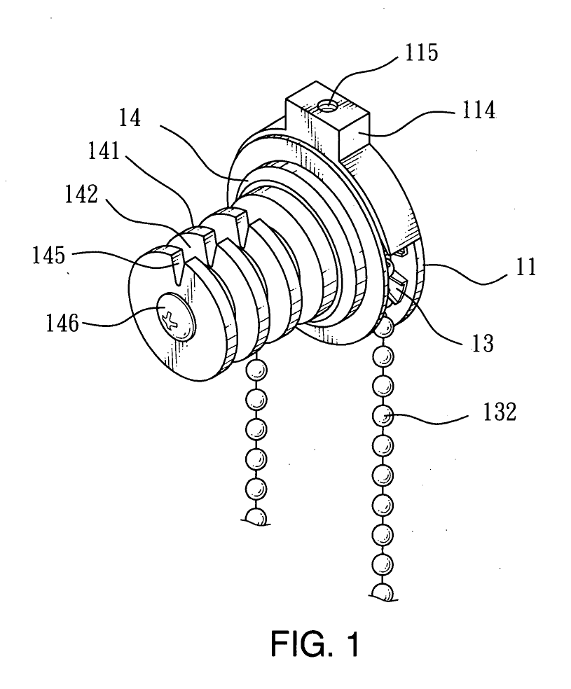

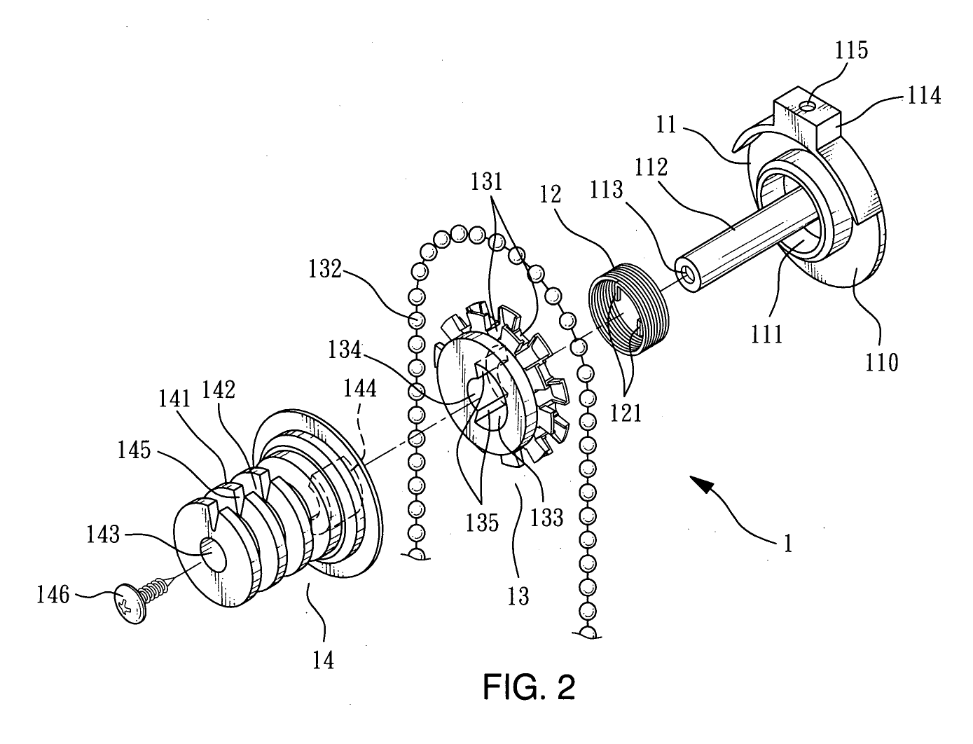

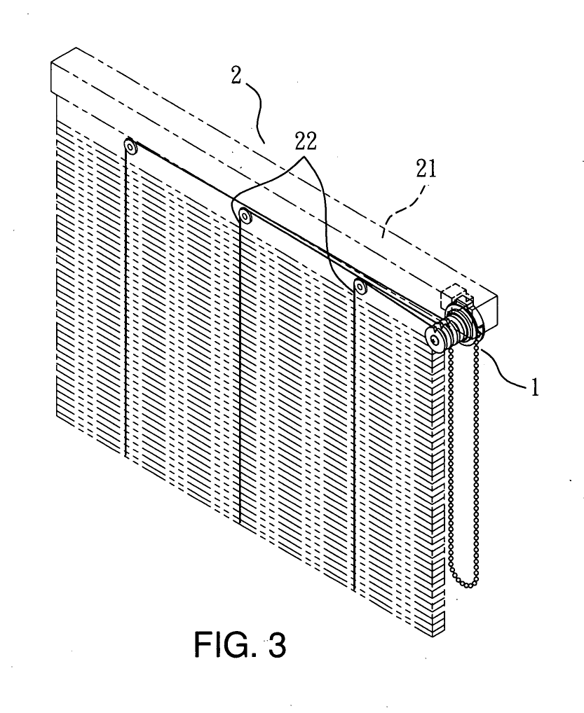

Referring to FIGS. 1, 2 and 3, the winding apparatus 1 according to the invention includes an anchor dock 11, an elastic element 12, a rotary wheel 13 and a cord winding dock 14.

The anchor dock 11 is installed on a transverse rod 21 of a shade 2 (the transverse rod is a bar or a bar with a track formed thereon), and has an inner side 110 with anchor axle 112 mounted onto the center. The anchor axle 112 has a distal end with a first screw hole 113 formed thereon. The anchor axle 112 is surrounded by an annular holding trough 111. The anchor dock 11 has a coupling portion 114 on an outer side that has at least one second screw hole 115 to be fastened by a fastening element.

The elastic element 12 is held in the holding trough 111 and has two legs 121 on two ends.

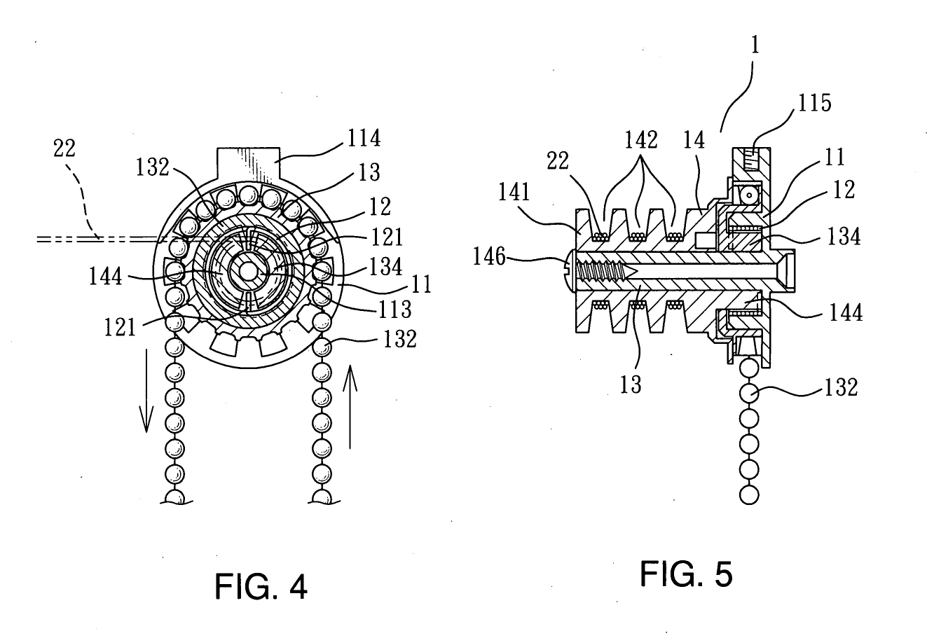

The rotary wheel 13 is coupled on the anchor axle 112 and has a plurality of ball troughs 131 on the periphery to be driven by an operation element 132 (the operation element is a ball chain as shown in FIG. 4). It has a coupling aperture 133 in the center and a thrust member 134 extended rearwards from one side where the coupling aperture 133 is formed to be coupled in the elastic element 12. The thrust member 134 has two thrust surfaces 135 pushing by the two legs 134 of the elastic element 12 to control rotation of the rotary wheel 12.

The cord winding dock 14 is coupled on a front side of the rotary wheel 13 and has a winding shaft 141 on one end that has at least one trough 142 to be wound by a drawing cord 22 and one notch 145. The drawing cord 22 has one end fastened to the notch 145. The cord winding dock 14 has another end with a coupling member 144 located thereon to wedge in the coupling aperture 133 of the rotary wheel 13 so that they can rotate synchronously. The cord winding dock 14 further has an opening 143 in the center to be run through by the anchor axle 112. The first screw hole 113 is fastened by a screw 146 to anchor all the elements mentioned above.

Referring to FIGS. 4 and 5, when the operation element 132 is moved to drive the rotary wheel 13, the thrust member 134 pushes one leg 121 of the elastic element 12 to rotate, the coupling member 144 also is driven to rotate the cord winding dock 14 at the same time so that the drawing cord 22 wound in the trough 142 is retracted or extended. As the cord winding dock 14 has more than one trough 142, it can drive a plurality of drawing cords 22 simultaneously. Therefore it overcomes the problem of the conventional techniques that have to provide a winding apparatus for each drawing cord that incurs a higher cost. The invention provides a simplified structure and can be fabricated faster. Fabrication and maintenance also are easier.

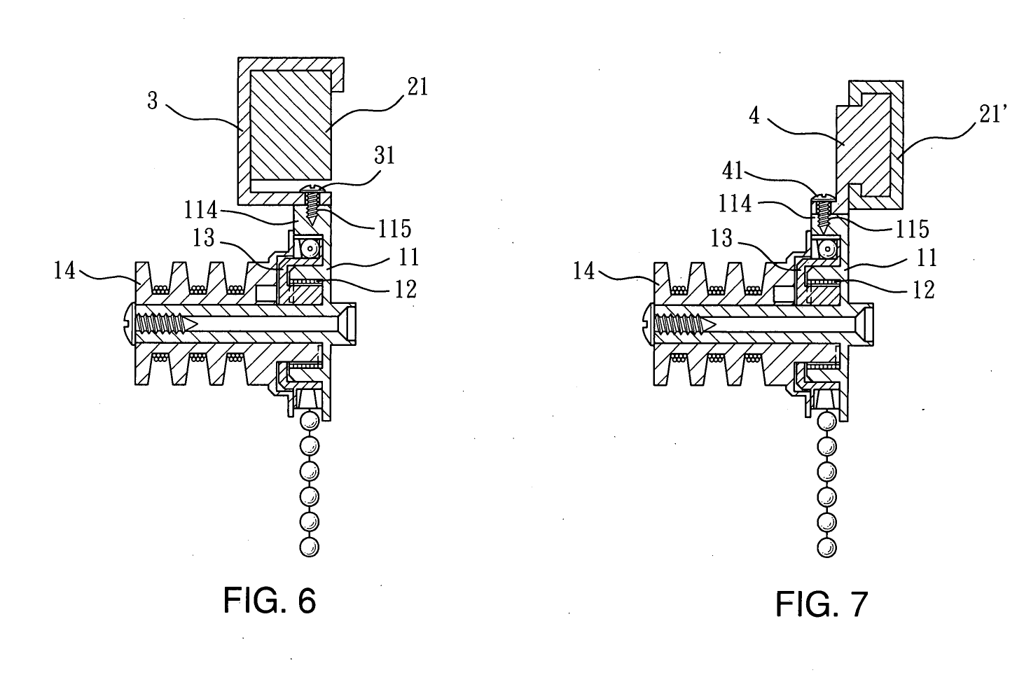

Referring to FIG. 6, the coupling portion 114 on the outer side of the anchor dock 11 has the second screw hole 115 to be fastened to a hanging hook 3 through a screw 31. The hanging hook 3 is hung on the transverse rod 21.

Referring to FIG. 7, the coupling portion 114 on the outer side of the anchor dock 11 may also be fastened to a sliding member 4 through a screw 41. The sliding member 4 is coupled in the transverse rod 21′.

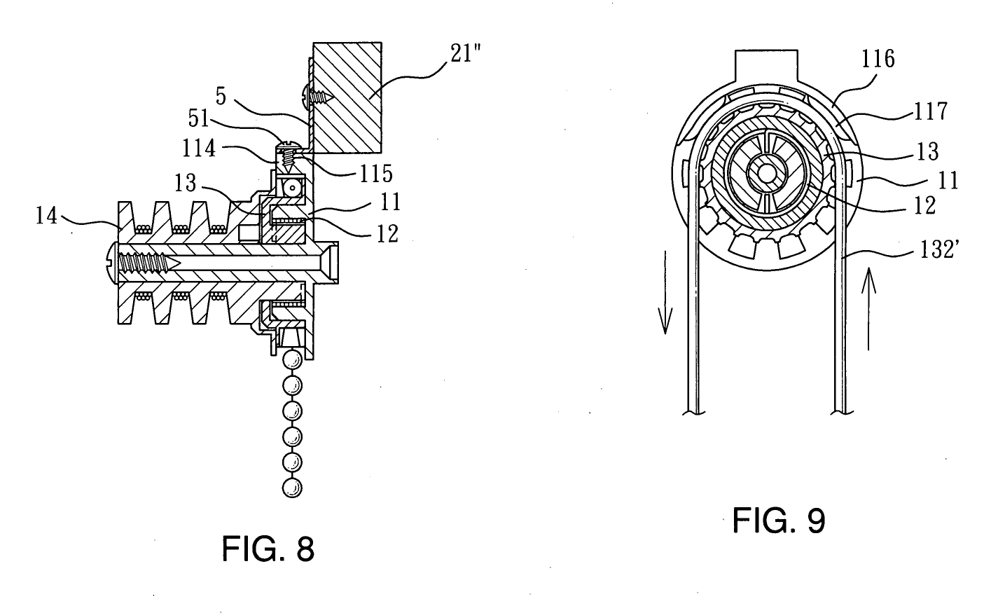

Referring to FIG. 8, the coupling member 114 on the outer side of the anchor dock 11 may also be fastened to a hanging plate 5 through a screw 51. The hanging plate 5 is fastened to the transverse rod 21″.

Referring to FIG. 9, the operation element 132 may be a rope 132′. The anchor dock 11′ has a guarding cover 116 on a upper side with a rib 117 formed respectively on two inner sides to clamp the rope 132′. Thereby more friction is generated to smooth the rotation of the rotary wheel 13.

In short, the invention provides a simple structure and can be fabricated easier at a lower material cost. It offers a significant improvement over the conventional techniques.

I claim:

1. A winding apparatus for shades comprising an anchor dock, an elastic element, a rotary wheel and a cord winding dock, wherein:
the anchor dock is installed on a transverse rod of a shade and has an inner side which has an anchor axle mounted onto the center thereof, the. anchor axle being surrounded by an annular holding trough;
the elastic element is held in the holding trough and has two legs on two ends;
the rotary wheel is coupled on the anchor axle and driven by an operation element to rotate, and has a coupling aperture in the center and a thrust member extended rearwards from one side where the coupling aperture is formed to couple in the elastic element, the thrust member having two thrust surfaces pushing by the two legs of the elastic element to control rotation of the rotary wheel; and
the cord winding dock is coupled on a front side of the rotary wheel and has a winding shaft on one end that has at least one trough to be wound by a drawing cord and a coupling member on another end to wedge in the coupling aperture of the rotary wheel, and an opening in the center to be run through by the anchor axle.

2. The winding apparatus of claim 1, wherein the operation element is a ball chain.

3. The winding apparatus of claim 1, wherein the operation element is a rope.

4. The winding apparatus of claim 1, wherein the anchor dock has a guarding cover on a upper side that has a rib on each of two inner sides thereof.

5. The winding apparatus of claim 1, wherein the anchor dock has a coupling portion on an outer side.

6. The winding apparatus of claim 5, wherein the coupling portion is fastened to a hook.

7. The winding apparatus of claim 5, wherein the coupling portion is fastened to a sliding member.

8. The winding apparatus of claim 5, wherein the coupling portion is fastened to a plate.
